(19) United States
(12) Patent Application Publication
(10) Pub. No.: US 2013/0010068 A1
(43) Pub. Date: Jan. 10, 2013

(54) AUGMENTED REALITY SYSTEM

(75) Inventors: Timothy C. Tiernan, Newton, MA (US); Kevin Grant Osborn, Newton, MA (US); Thomas Anthony Keemon, JR., Allston, MA (US); Robert Vinci, Harvard, MA (US)

(73) Assignee: Radiation Monitoring Devices, Inc., Watertown, MA (US)

(21) Appl. No.: 13/445,448

(22) Filed: Apr. 12, 2012

Related U.S. Application Data
(60) Provisional application No. 61/474,652, filed on Apr. 12, 2011.

(51) Int. Cl. G06T 15/00; H04N 13/02

(52) U.S. Cl. 348/46; 345/419; 348/E13.074

(57) ABSTRACT

Methods and systems for providing an augmented reality system are disclosed. In one instance, an augmented reality system may: identify a feature within a three-dimensional environment; project information into the three-dimensional environment; collect an image of the three-dimensional environment and the projected information; determine at least one of distance and orientation of the feature from the projected information; identify an object within the three-dimensional environment; and perform markerless tracking of the object.

### RELATED APPLICATIONS

This application claims the benefit of U.S. provisional application Ser. No. 61/474,652 filed Apr. 12, 2011, which is incorporated herein by reference.

### GOVERNMENT SPONSORSHIP

This invention was made with U.S. Government support under SBIR contract number M67854-09-C-6505, awarded by the U.S. Department of Defense. The Government has certain rights in this invention.

### BACKGROUND

While augmented reality is not yet a familiar term to everyone, most have experienced augmented reality in numerous ways. One specific application of augmented reality that is familiar to most people is the line of scrimmage and first down lines shown during a televised broadcast of a football game. The lines are not “real”, they are added by the television producer. Furthermore, these lines augment the reality seen by the viewers of the football game and provide valuable information about the status and outcome of each play. Other examples of augmented reality include smartphone applications (apps) by which the user can hold their phone in such a way that its integrated camera shows the real world with additional information about what is in the image, such as the cost of a house for sale. There are other more involved applications of augmented reality. However, regardless of the specific application, augmented reality in essence, provides information that augments what an operator's senses normally experience during any number of different situations and applications.

### SUMMARY

The inventors have recognized the benefits of providing an augmented reality system that may be capable of automatically identifying and tracking features within a three-dimensional environment for the purpose of projecting information into the three-dimensional environment to instruct an operator in a specific procedure.

In one embodiment, a method for providing an augmented reality includes the steps of: identifying a feature within a three-dimensional environment; projecting first information into the three-dimensional environment; collecting an image of the three-dimensional environment and the projected information; determining at least one of distance and orientation of the feature from the projected first information in the collected image; identifying an object within the three-dimensional environment; and performing markerless tracking of the object.

In another embodiment, a method for providing augmented reality includes the steps of: collecting visual information of an environment; identifying a plurality of features within the environment; comparing the plurality of features to a visual signature to identify a situation; performing markerless tracking of the plurality of features; and providing a visual prompt to a user regarding the identified situation.

In yet another embodiment, a method for providing augmented reality authoring includes the steps of using markerless identification to identify an object; providing a user interface for labeling features on the identified object in an augmented reality; and tracking the labeled features on the identified object.

In one embodiment, a method for providing augmented reality includes the steps of: providing a light source; projecting information into a three-dimensional environment with the light source; collecting an image with a camera, wherein the image comprises the information projected into the three-dimensional environment; determining a first coordinate system of the camera from the information projected into the three-dimensional environment; determining a second coordinate system of the light source from the information projected into the three-dimensional environment; and determining a relative offset between the first and second coordinate systems.

In another embodiment, a method for providing augmented reality includes the steps of: providing a camera; collecting a first image of a three-dimensional environment with the camera; automatically identifying a situation; automatically determining an action to be performed from the identified situation; performing the determined action; collecting a second image of the three-dimensional environment with the camera; and determining a response to the performed action.

In yet another embodiment, an augmented reality system may include a camera, a light source, and a controller. The controller may be adapted to: send a signal to the light source to project first information into a three-dimensional environment; receive a signal from the camera, identify a feature in the environment; determine at least one of distance and orientation of the feature using the first information; determine at least one of distance and orientation of a feature in the environment from the signal from the camera; identify an object within the three-dimensional environment; and track the object using markerless tracking.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic representation of an augmented reality maintenance system applied to a maintenance procedure of a device;

FIG. 2 is a schematic representation of a device with information projected onto its surface;

FIG. 3 is a schematic representation of an augmented reality maintenance system integrated into a workbench;

FIG. 4 is a schematic representation of an augmented reality maintenance system integrated into a vest;

FIG. 5 is a schematic representation of an integrated augmented reality maintenance system;

FIG. 6 is a schematic representation of an augmented reality maintenance system mapping a three-dimensional environment;

FIG. 7 is a schematic representation of an off-site management station;

FIG. 8 is a schematic representation of a plurality of augmented reality maintenance systems communicating over a network and/or the Internet;

FIG. 9 is an image uncorrected for radial distortion;

FIG. 10 is an image corrected for radial distortion;

FIG. 11 is an image of the calculated coordinate system overlaid on a three-dimensional environment with a plurality of identified features;

FIG. 12 is an image depicting labeled features and the software menu for identifying and labeling the features;

FIG. 13 is an image depicting the labeled features tracked and identified in another orientation;

FIG. 14 depicts an augmented reality system guiding a user through a door;

FIG. 15 depicts an augmented reality system instructing a user on a touchpad; and

FIG. 16 depicts an augmented reality system instructing a user on a computer repair.

### DETAILED DESCRIPTION

Currently, maintenance of complex equipment requires highly trained individuals and is labor intensive, expensive and inefficient. Often times, technicians use written technical manuals to direct them through complex maintenance procedures including, for example, condition based maintenance procedures. These manuals may either be written manuals or Interactive Electronic Technical Manuals (IETM). Regardless of the particular format, these manuals must be referenced and written by the maintainer to find the exact details needed for a particular repair. Searching the documents for relevant data can be difficult and requires significant time. Furthermore, oftentimes the documents are clumsy to handle during complex maintenance procedures that frequently take place in hot, dusty, and/or cramped environments. In addition, many components do not have standard operating procedures (SOP) for repair so the technical data needed for troubleshooting and maintenance is often incomplete or unavailable due to time constraints and proprietary component design. Consequently, substantial training is usually required to understand the manuals that do exist and to learn proper repair techniques for a given procedure.

The inventors have recognized that traditional augmented reality systems suffer from both technological and human factors drawbacks as related to providing instructions and/or guidance to the maintainer during a repair procedure. The technological limitations of many systems include clumsy, expensive and uncomfortable equipment and eyewear as well as high-power requirements, expensive electronics, and the requirement of extremely high precision tracking systems. Perhaps more important are the human factors issues recognized by the inventors which include, for example, vertigo, eyestrain, diversion of attention from the task at hand, cognitive overload due to excessive images and information, and loss of focus and efficiency. Without wishing to be bound by theory, the inventors believe that many of the above noted problems may be due to many augmented reality systems relying on highly detailed images being superimposed with normal reality. Furthermore, the inventors have recognized that traditional augmented reality systems requiring, for example, clumsy headgear, wiring, and a high precision tracking system may not be practical in applications outside of a controlled laboratory setting including, for example, a car repair depot during a hot and humid summer.

In view of the above, the Inventors have recognized that it may be desirable to provide an augmented reality system where the operator's head, eyes and hands are free from equipment and wires. Instead, select information may be projected directly into the three-dimensional environment by an associated camera and light source using markerless identification and tracking processes. In some instances, the information may be a structured image (such as a geometric shape) that is projected into the three-dimensional environment. In addition, it may also be desirable to provide a voice controlled system such that hands free operation may be enabled through the use of voice command and control. Such a system could leave a user's hands free to perform manual work during a procedure and may also help to prevent cognitive overload of the operator.

In order to simplify the complexity of the tracking system, it may be desirable to perform tracking without the use of a global positioning system or other external sophisticated tracking systems. In such an embodiment, tracking may be done using a camera and projector integrated into the augmented reality system. The integrated camera and projector may be used to automatically determine the distance, size, shape, color, speed, and any other desired characteristic of features and/or objects in the environment. The augmented reality system may also create a three-dimensional map of the world where a procedure is to be performed.

Once the augmented reality system has created a three-dimensional map of the environment, it may use simple visual cues and voice prompts to direct and/or instruct a maintainer. This information may be visually observable information projected directly into the environment to guide a user through a procedure. This may include, for example, text, icons, symbols, arrows, circles, shapes, points, and any other desired visual cue. The visual information may move or it may remain stationary as appropriate. The visual information projected into the environment may be provided in concert with audio cues to further guide the user through the procedure.

For the sake of clarity, the embodiments described below are primarily directed at an augmented reality system for use in a conditions-based maintenance or repair process. However, the current disclosure should not be limited in this regard. Instead, the current disclosure should be interpreted generally as disclosing an augmented reality system that may be used in any number of applications including, but not limited to, condition-based maintenance, training, repair, planning, operations, manufacturing, and education.

In one embodiment, the augmented reality system may be an augmented reality maintenance system 102 which may be integrated either in a mobile or bench mounted system as described in more detail below. In mobile embodiments, the augmented reality maintenance system may further be wearable by an operator.

The augmented reality maintenance system may include a built-in ability to perform three-dimensional recognition of its environment as described in more detail below. For example, the augmented reality maintenance system may automatically identify a circuit board, or any other appropriate device, using images provided by an integrated camera 106. The information received by the camera may be used to perform both markerless tracking and mapping of the environment and devices within the environment. In some instances, the camera may be combined with a light source 104 to aid in mapping the environment. For example, changes in the size and shape of information projected into the environment by the light source as imaged by the camera may be used to determine the distance and orientation of a feature relative to the camera. In some embodiments, it may be necessary to determine a relative offset between the coordinate systems of the camera and light source to accurately calculate distances and orientations.

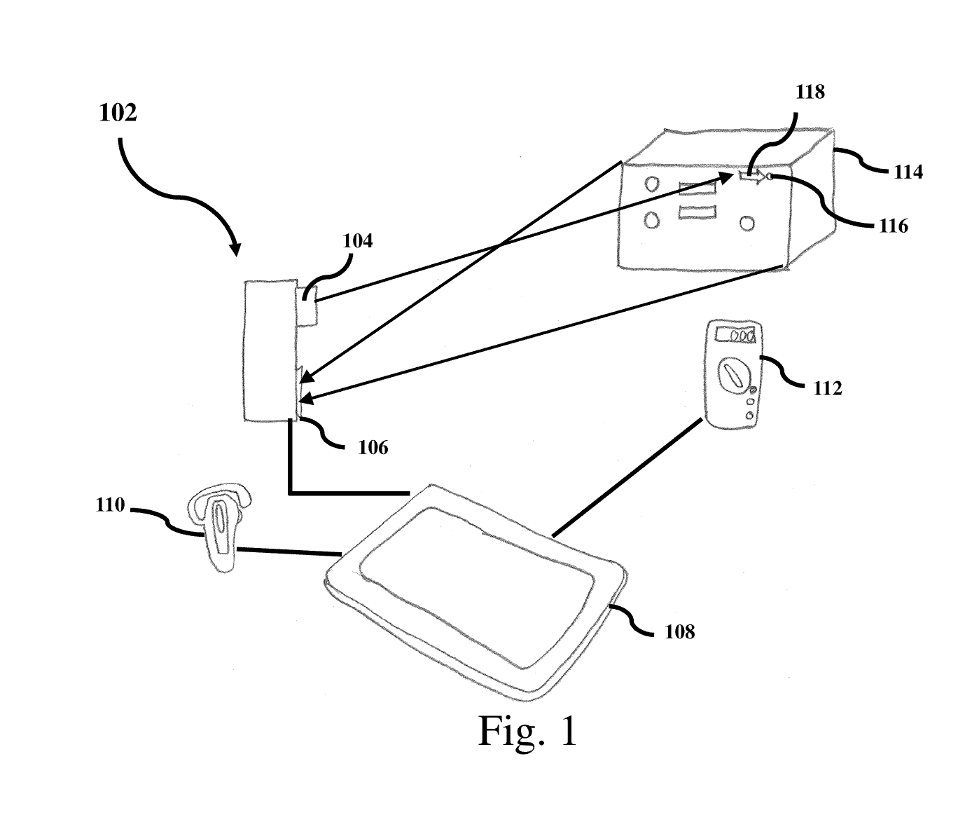

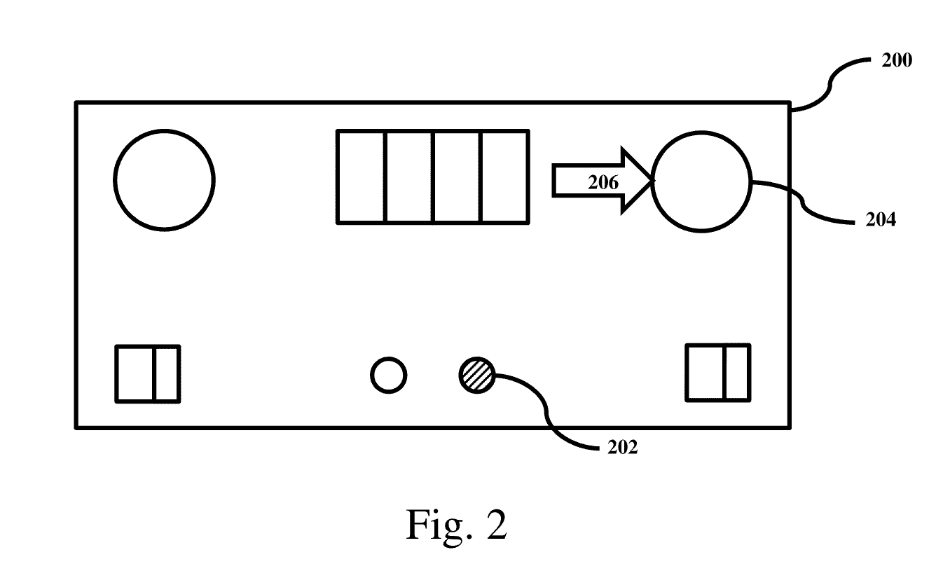

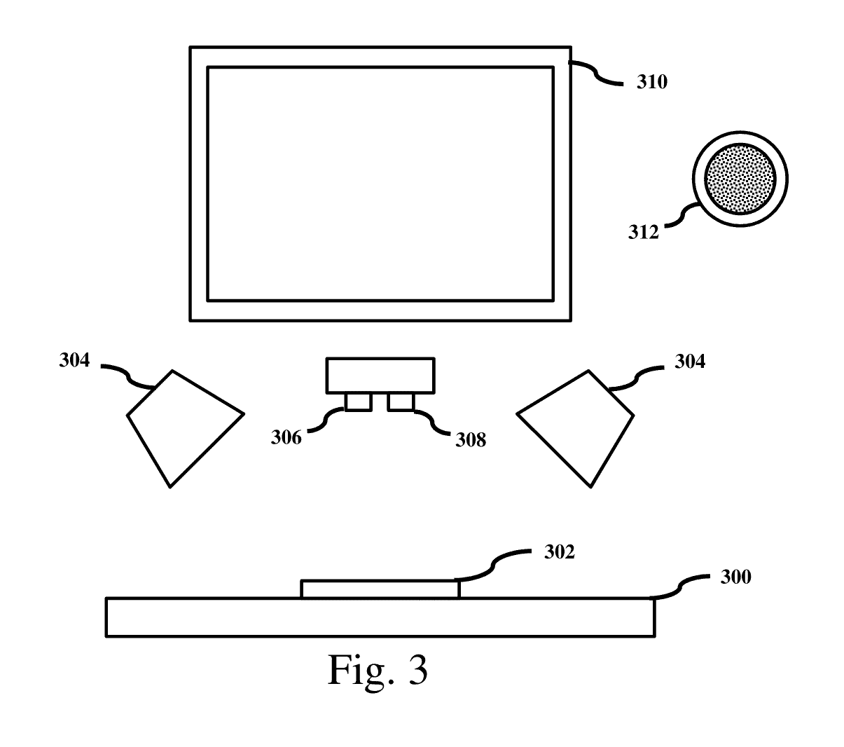

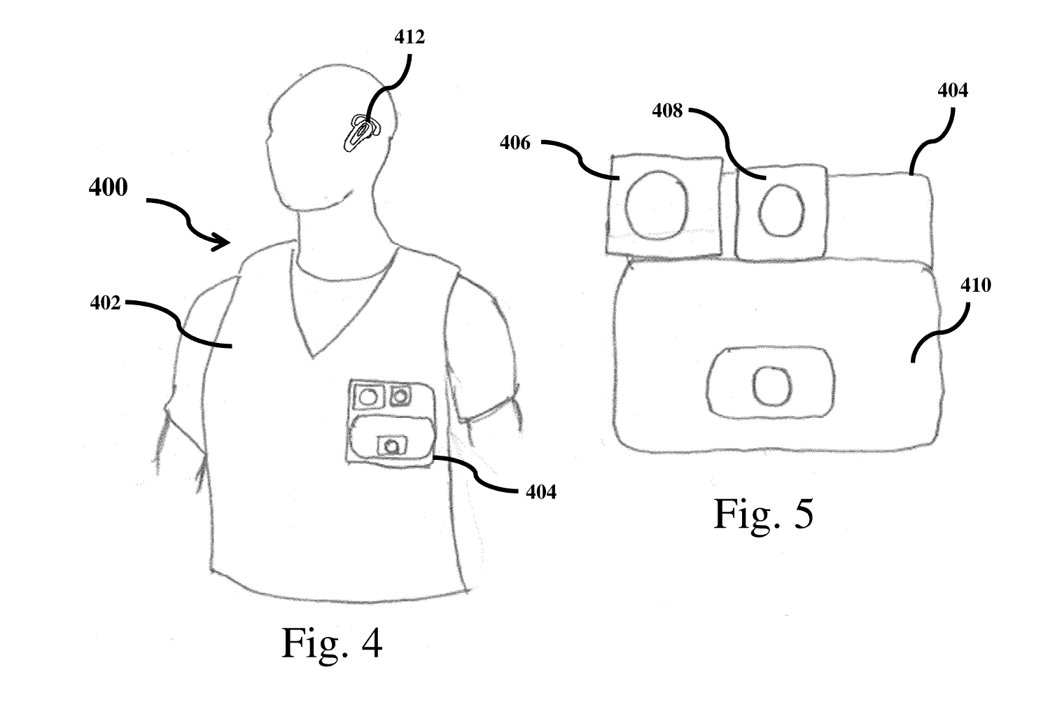

In addition to tracking and mapping features within the environment, the augmented reality maintenance system may also provide real-time assistance to an operator by using the light source to project visual information onto the device identified in the environment to guide the operator through a specific procedure. This information may be supplemented by the use of additional graphical, text, and/or voice prompts. The augmented reality maintenance system may also provide the maintainer with relevant data on an as-needed basis by projecting, for example, part numbers and/or other indicating shapes or symbols directly onto the device using the light source to indicate various parts and points of interest on the device. As depicted in FIG. 1, the visual information may be an arrow 118 projected onto device 114 to indicate a point of interest 116.

While a laser projector has been disclosed above, it should be understood that any appropriate light source capable of projecting information into the environment could be used. For example, appropriate light sources might include, but are not limited to, laser projectors, optical projectors, picoprojectors, microprojectors, laser pointers, or any other applicable device. In addition it may be desirable that the light source be safe for unshielded eyes and/or viewable in daylight.

To provide the noted audible capabilities, it may be desirable to incorporate an audio device 110 with the augmented reality maintenance system. The audio device may enable voice command and control of the augmented reality maintenance system and/or audible prompts and instructions to the operator. In order to avoid unnecessary wires and connections attached to an operator during a procedure, it may be desirable to provide a wireless connection between the audio device and the augmented reality maintenance system. However, it should be understood that the disclosure is not limited in this fashion and that an audio device could include a hardwired connection as well. Furthermore, it should be understood, that depending upon the specific embodiment, the audio device may be an audio input and/or output device.

In some embodiments, it may be desirable that the augmented reality maintenance system output information to a viewing screen 108 in addition, or as an alternative, to the information projected into the environment. This viewing screen may either be a portable handheld computing device such as a tablet computer, or it may be a standalone monitor. In either case, images of the device being repaired as well as information related to it may be displayed on the viewing screen. For example, it may be desirable that the augmented reality maintenance system automatically fetch and display the part numbers, schematics, data sheets, and other information relevant to the maintenance process on the view screen.

In some embodiments, it may be desirable that the augmented reality maintenance system be designed to complement rather than change familiar, existing, workflow maintenance procedures. For example, many electronic maintenance procedures rely on the use of a curve tracer and gold-standard comparisons in addition to other testing equipment and procedures. Therefore, in one embodiment, the augmented reality maintenance system may assist an operator by displaying a gold standard curve for each component on the circuit board for immediate comparison to a curve measured by a curve tracer during circuit maintenance. To further enhance this benefit, it may be desirable that the augmented reality maintenance system integrate a curve tracer, or other diagnostic tool 112 such an infrared sensor, a high resolution camera, an oscilloscope, a current probe, a voltage probe, or an ohmmeter. Thus, the augmented reality maintenance system may receive a signal from one or more integrated diagnostic tools and may automatically compare it with an applicable gold standard or other defined operating characteristic.

In addition, to integrating some test equipment, the augmented reality maintenance system may also enhance the speed and efficiency of a repair procedure by automatically locating and retrieving the schematic and parts layout for the identified device. The schematic may then be posted automatically on a large computer monitor, or a tablet computer for mobile application, next to an image of the actual device (being recorded by the camera). The display may also depict the augmented reality part numbers as well. This approach may help the operator to quickly find the parts in the ambiguity group and provides a schematic to assist in diagnostics when needed. In another embodiment, when the operator either points to a component on the device, or in the displayed image, the same component may be highlighted in the schematic making it easier to see where any component is in the schematic drawing. Similarly, when a component in the schematic drawing is selected, the augmented reality maintenance system may automatically highlight that component on the device and/or display the data sheet for that component so that the maintainer may get pertinent information on the function of each component, and the purpose of each pin on an integrated circuit. The augmented reality maintenance system may display the proper gold standard curve trace, or other appropriate performance criteria, by clicking on any component to confirm component functionality without the need for paper documentation.

In some instances, it may be desirable that the augmented reality maintenance system include a capability for feedback control of a device or system. For example, an augmented reality maintenance system may identify a device 200 and a situation as indicated by an indicator 202. The indicator may indicate, for example, that the device is operating outside of normal operating limits. The augmented reality maintenance system may then indicate to an operator that a dial 202 should be adjusted by projecting an arrow 204 onto the device. After the dial has been adjusted, the augmented reality maintenance system may confirm that the device has returned to nominal operation by, for example, determining if the indicator has returned to normal. Alternatively, the augmented reality maintenance system may be able to directly control operation of the device. In such an instance, the augmented reality maintenance system may adjust the device operation to return it to nominal operation. The return to nominal operation may again be automatically determined by the augmented reality maintenance system by monitoring the status of the indicator.

While a simple device and indicator have been disclosed above, the current disclosure is not limited to a specific device, the detected faults, or the indication method. For example, feedback control could be implemented in any number of situations and industries including, but not limited to, indicators and controls in aviation cockpits, manufacturing processes, maintenance procedures, trains, ships, control rooms, and other situations where feedback control may be of value. Furthermore, multiple indicators and multiple types of indicators such as electronic indicators, electronic signals, gauges, indicator LEDs, and other desirable indicators may be monitored individually or together by the augmented reality maintenance system.

To provide an augmented reality maintenance system capable of identifying devices and components, as well as guiding an operator through a procedure as detailed above, it may be desirable to implement markerless tracking and identification processes. Such methods may include, for example, a computational technique known as Simultaneous Localization and Mapping” (SLAM) may be used. SLAM describes a collection of methods, often used in robotics, that are helpful in exploring unknown environments. After being provided with any type of sensor input, a SLAM algorithm is comprised of two parts. Namely, recording the pose of the sensor (i.e. its position and attitude) within an environment (i.e. Tracking) and stitching together a map of the unknown environment from the sensor input (i.e. Mapping). In one embodiment, the augmented reality maintenance system may implement SLAM utilizing sensor input from a camera. In this approach, the tracking and mapping functions may be run in two separate threads. The tracking thread searches each frame for strong features, which it may keep track of in order to predict the camera's orientation and motion. The mapping thread may run significantly slower using select key-frames and a technique called bundle adjustment in order to simultaneously refine the pose of the camera and add information to the “map” of an environment. Due to separating these two tasks and running them in parallel, a single computing device, such as a laptop, may be capable of creating an accurate model of an environment with an associated coordinate system in real-time. By creating a model of the environment, the location of the camera and identified features may be tracked. This information may be used to provide useful advice to its user.

In one embodiment, it may be desirable to determine the relative offset between a coordinate system of the camera and a coordinate system of a light source projecting information into the environment. Without wishing to be bound by theory, determining the relative offset between the coordinate systems may enable the augmented reality maintenance system to accurately project information onto specific identified features within the environment. Thus, it may be possible to accurately project information on to specific features within the environment to guide and/or inform the operator.

In another embodiment, the augmented reality maintenance system may advantageously identify a device, a component, or a situation. For example, the identified features noted above may be compared to a database containing a plurality of signatures corresponding to various devices and components. In some instances the signatures may contain a subset of features previously identified for a particular device or component. Thus, it may not be necessary to match each feature identified within the environment to identify a particular device or component. Due to using a subset of the features present on a device or component, it may also be possible to readily identify the device or component in multiple orientations and environments when not all of the features may be visible to the camera. In some instances, multiple signatures may have similar patterns of identified features. In such instances, when a pattern of features are identified within the three-dimensional environment corresponding to more than one signature, secondary more detailed signatures including additional features may be used to distinguish between the different devices or components. After identifying a particular device or component present within the three-dimensional environment, the augmented reality maintenance system may further identify a situation regarding the device and/or component. For example, the augmented reality maintenance system may identify a printed circuit board and may subsequently determine that a repair procedure should be initiated.

When using sensor input from a camera it may be necessary to overcome the distortion of the image provided by the camera. Due to the shape of the camera's lens, light rays reflecting off of an object in the environment and onto the camera's imaging sensor do not represent a perfect three-dimensional to two-dimensional orthogonal projection. Therefore, to accurately track features and map surfaces it may be desirable to correct for these distortions. In one embodiment, these distortions may be rectified by using a camera to image a known pattern at multiple distances and orientations. Based on how the images compare to the known pattern, the internal (intrinsic) camera properties and the external (extrinsic) camera pose may be computed. The intrinsic values may then be used to compute the image distortion as a property of the lens.

The augmented reality maintenance system may also include training software to provide a built-in “learning” component in a system. In one embodiment, the training software may be a software program and toolbox that enables the user to label identified features within a captured image. For example, a content author may label components in an image of a device with part numbers or other appropriate identifiers, link documents to the identified components, and create voice prompts associated with the identified components. The training software may also enable supervisory personnel and planners to program the augmented reality maintenance system to assist with any task in any environment. In one embodiment, the training program may be used with the same camera, projector, electronics, and software present on the augmented reality maintenance system. In such an embodiment, the training software may create and store three-dimensional information of the environment and use identified features, such as the edges of components, to triangulate the position of everything on a device. Using a tool box generated by the software, the content author may then place virtual icons on important objects in the environment so the camera and associated the augmented reality maintenance system may then “recognize” these objects during a maintenance procedure. The process of locating and mapping items in the environment may be followed by creating a work plan that is conveyed to the operator through visual cues from the light source and audio cues from an audio device. After creation, the work plan and associated materials generated with the training software may be provided to an operator. Thus, the augmented reality maintenance system may then guide and/or instruct the operator through the procedure documented by the content author.

Currently, in normal maintenance operations, data for a broken device is logged in by hand. This can be a tedious and time-consuming procedure and some aspects of the procedure may be skipped by an operator. As a result, databases are often times incomplete and not readily computerized. Therefore, it may be desirable that the augmented reality maintenance system automatically document maintenance operations and make appropriate entries in a database regarding, for example, the device being repaired, operator information, the specific ID and general type of device being tested and repaired, the particular repair performed, the number and type of parts used, the conditions under which a device was used, how many hours the device was used , and other pertinent information. In one embodiment, the augmented reality maintenance system may automatically log information whenever a component or device is tested, thus providing information related to general components and specific devices. Due to the automatic logging of information regarding the performed repairs, the assembled database may be useful for providing statistical information on: the most likely defects in any particular device that is about to be repaired; which components to inspect first during a repair procedure, components or devices needing possible redesign, how many of a particular component to keep in inventory; and estimating the cost, time, probability of completing a repair. Using the data base, the augmented reality maintenance system could also warn an operator when a device cannot be repaired due to lack of parts or other limitation. Information could also be entered into the system by planners to flag certain broken parts for special treatment.

In view of the above, the augmented reality maintenance system can help planners decide whether repairs should be made. Using the data base and flags entered into the system by planners, the augmented reality maintenance system could inform the operator whether a device should be repaired. For example, planners may decide that certain devices do not need repair because they are obsolete or too expensive to repair. On the other hand, the augmented reality maintenance system planner could program the augmented reality maintenance system to flag certain parts for repair that are most needed, and add information to expedite the repair process.

While documenting information related to the maintenance procedure, the augmented reality maintenance system may also track the operator's performance using images from its camera. Specifically, parameters such as the rate of repair, number of errors, and the frequency and type of help requested during an operation may be logged and used to tailor information offered to a specific operator. For example, a more skilled operator may require less information and prompting during a procedure than a new operator would. In some embodiments, the images and data from a repair procedure may be ported to tablet computers, PCs, networks, and/or servers for data analysis and planning purposes. Thus, the augmented reality maintenance system may be used for certification purposes and automatically documenting actions and proficiency levels of individual operators. The augmented reality maintenance system may also incorporate networking features to provide team leaders the ability to monitor and interact with individual operators as they work for the purposes of training and/or guidance. To accurately identify individual operators, it may be desirable to securely log-in an operator using a secure recognition system using a fingerprint, a voice pattern, a retinal image, an username and password, a secure ID, or any other secure identification means.

In one embodiment, the augmented reality maintenance system may be incorporated into a workbench. The workbench may include, for example, a work surface 300 and light sources 304 that illuminate the work surface. The augmented reality maintenance system may also include a laser projector 306 and a color video camera 308 for identifying objects and projecting information into the three-dimensional environment as disclosed above. While specific projectors and cameras have been noted, any appropriate light source and camera could be used. A monitor 310 may also be associated with the augmented reality maintenance system for displaying additional information relevant to a procedure. In addition, or as an alternative, to the monitor, a tablet computer could also be used. Furthermore, either the monitor or computer tablet could include a touchscreen. The monitor and/or computer tablet may also be used for displaying text such as help files, movies or animations demonstrating procedures, or video or text communications with remote experts, if needed during a repair. An audio device 312 may be used for inputting and/or outputting audible commands. An operator using the workbench may be guided through a repair procedure of device 302 as described above. Device 302 may include, for example, a printed circuit board.

In another embodiment, the augmented reality maintenance system may be incorporated into a wearable system 400. For example, the wearable device may be embodied as a wearable vest 402. The vest may include an augmented reality maintenance system integrated into a single device 404. Similar to the embodiments described above, the integrated device may include a camera 406 and a light source 410. In some embodiments, the integrated device may also include an image inverter to rectify the projected image. Such an arrangement may allow the projector to be placed flat on the surface of the vest. Due to size and weight constraints, it may be desirable that the light source be small. For example, the light source may be a small scale laser projector, a picoprojector, or any other appropriate device. Due to the mobile nature of a worn device, it may also be desirable for the camera to be a wide field of view camera. This may enable the augmented reality maintenance system to view a larger portion of the three-dimensional environment for observation and tracking purposes. While not depicted, the mobile system may be associated with a tablet computer with a touch screen for displaying text such as help files, movies or animations demonstrating procedures, or video or text communications with remote experts, if needed during the repair. To enable voice command and control, audible instructions and warnings, and communications, the augmented reality maintenance system may further include an audio headset 412. The audio headset may be a wireless audio headset.

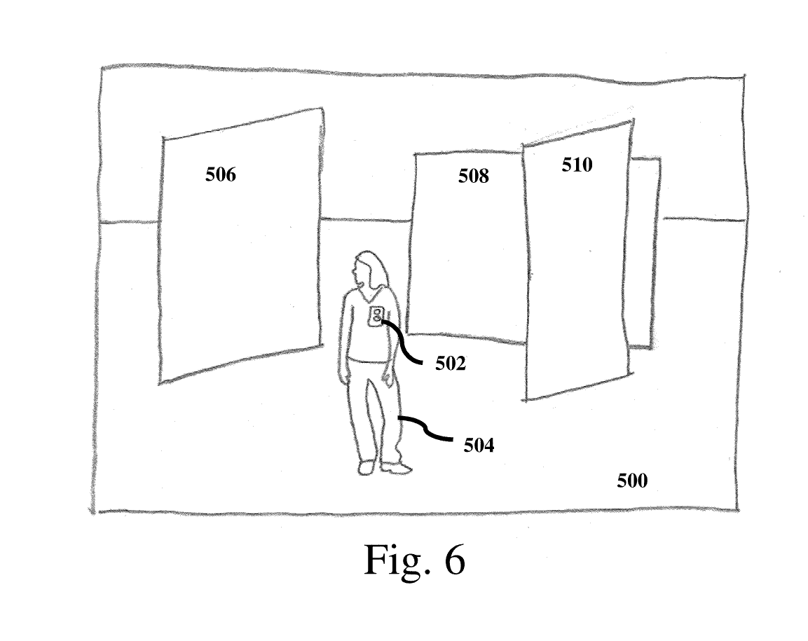

In certain embodiments, the augmented reality maintenance system may contain a single camera. As depicted in FIG. 6, a worn augmented reality maintenance system 502 may be worn by an individual 504. The system may be trained with the knowledge of a 360° map of an environment 500. In one embodiment, a mapping may include a set of maps 506-510 corresponding to different orientations within the environment. Consequently, the augmented reality maintenance system may determine the orientation of an operator within the environment by determining which map out of the set of maps corresponds to the current field of view. Thus, the augmented reality maintenance system may then direct the operator to look in a particular direction relative to their facing. In some instances, training of the augmented reality maintenance system may be done in as little as a few minutes for a simple environment, and information can be added to the map of the environment at any time. This may eliminate the need for the operator to know the direction to view in order to perform a task since the system will know what lies in all directions from any position of the maintainer in an environment, and direct his or her attention to the proper location. While a worn system has been depicted in Fig. F, it should be understood that the current disclosure applies to both worn and unworn devices.

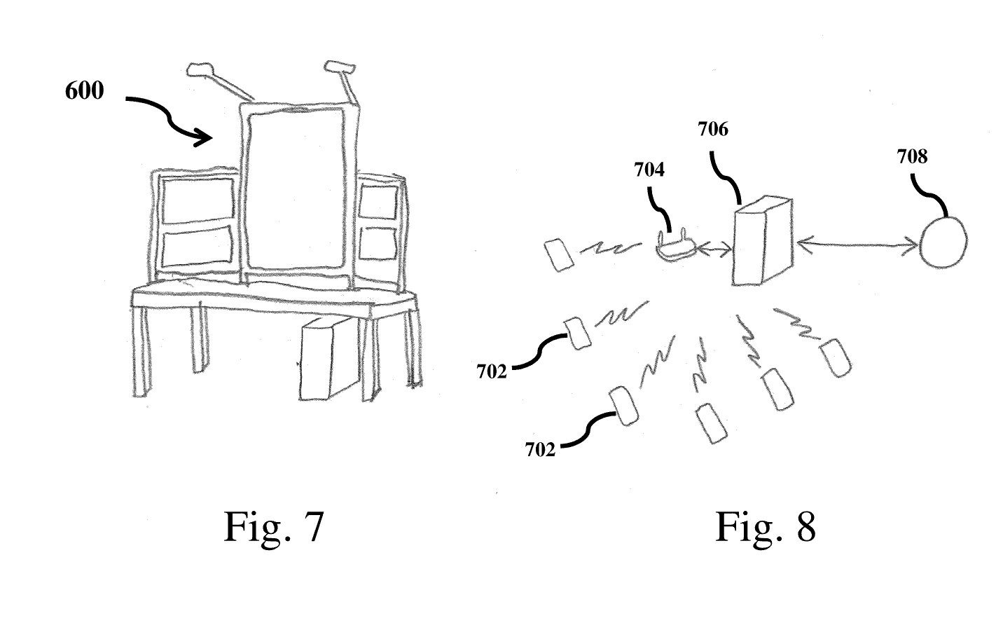

As noted above, after an augmented reality maintenance system has been trained with regards to a particular device and/or procedure this content may be provided to an operator. More specifically, the appropriate information may be uploaded to other augmented reality maintenance systems. Therefore, it may be desirable to provide the ability to connect a plurality of augmented reality maintenance systems 702 to each other and/or a central server 706, as depicted in FIG. 8. This may be accomplished either through hardwired connections or wireless connections 704. The various augmented reality maintenance systems may also be connected either directly, or through the central server 706, to external networks 708. These connections may advantageously enable an expert human to provide help to an operator on request. For example, a person may be able to view a video stream from individual augmented reality maintenance systems at a remote workstation 600, see FIG. 7. In addition to seeing a video stream from the augmented reality maintenance system, a person may also communicate with the individual operator. Thus, when an operator encounters a difficult problem beyond the computerized system's ability, they may receive guidance from an experienced person quickly and efficiently. Furthermore, the network connection may enable the actions performed using the augmented reality maintenance system and recorded with its cameras to be stored and possibly reviewed at any time by senior personnel for planning, training, or other applicable purposes.

### EXAMPLE

### Image Correction

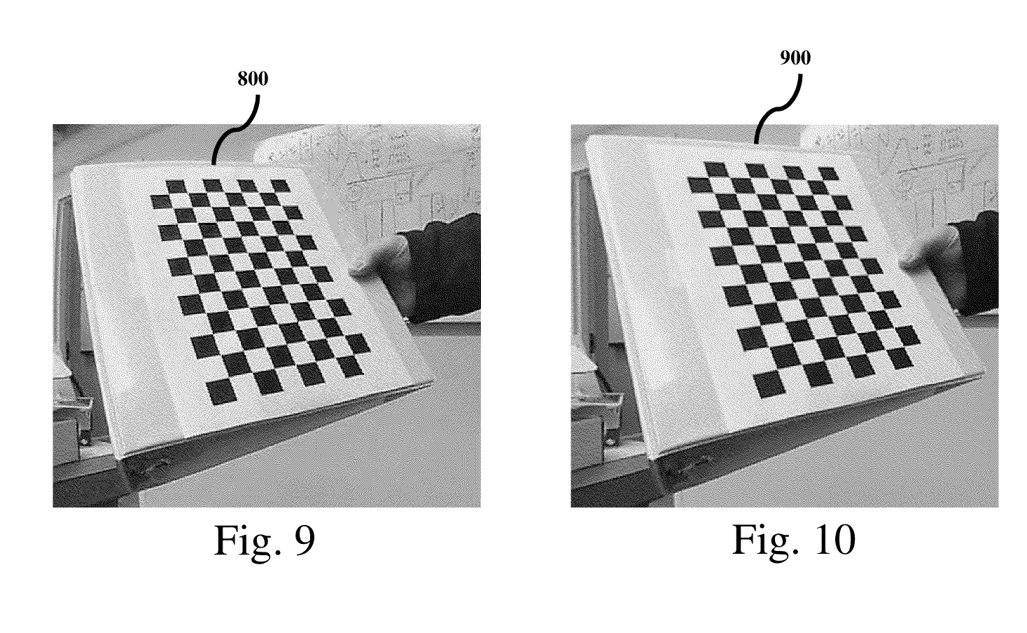

FIGS. 9 and 10 illustrate the difference between an image that is uncorrected for the lens distortion, i.e. image 800, and an image that has been corrected for the lens distortion, i.e. image 900.

### EXAMPLE

### Markerless Identification, Labeling, and Tracking

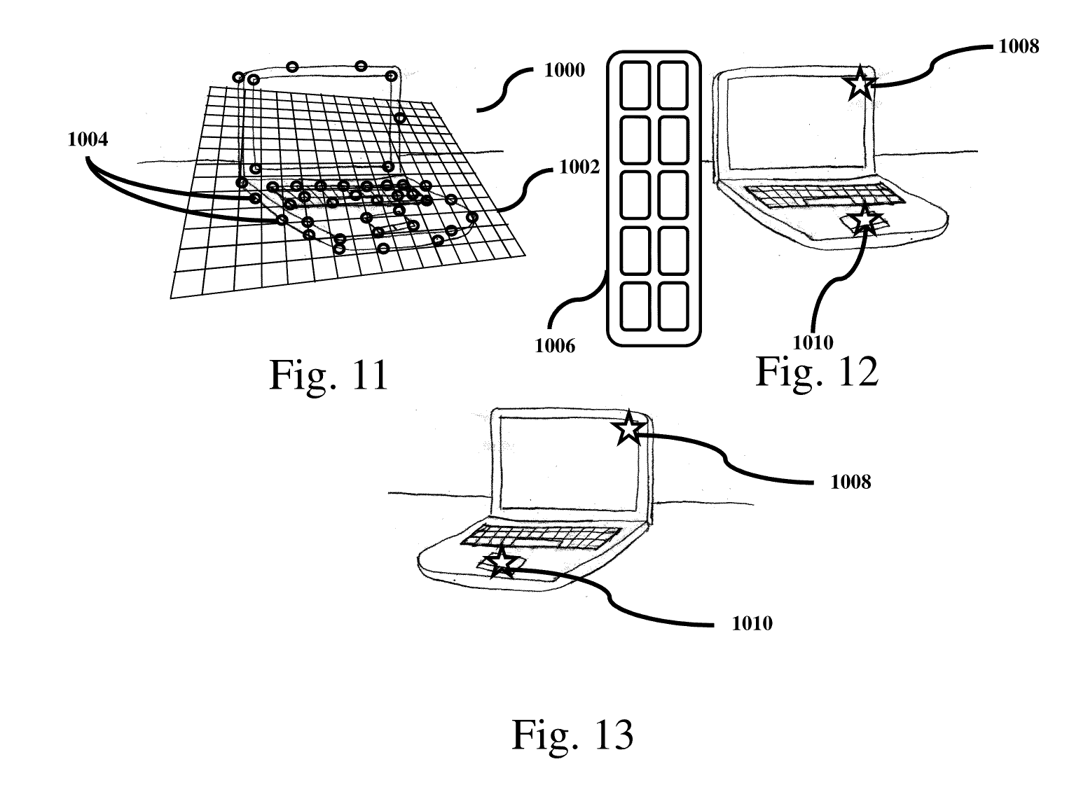

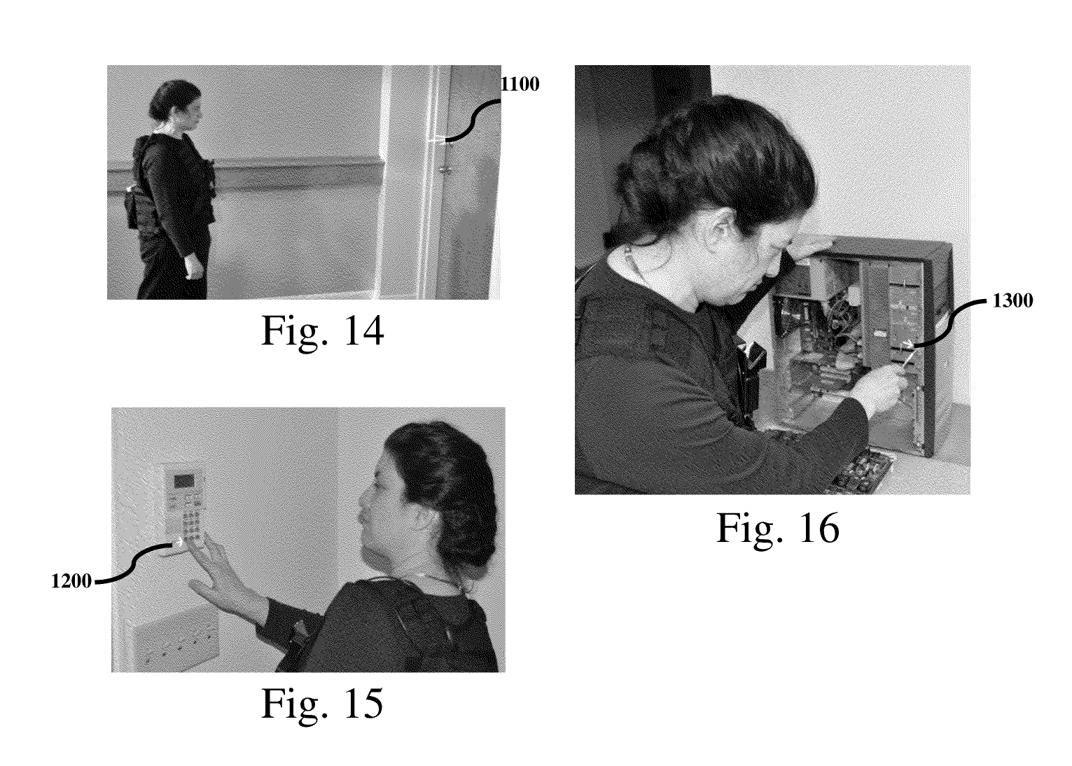

An example of an augmented reality maintenance system being used to identify and label specific features on a device located in a three-dimensional environment is shown in FIGS. 11-13. As depicted in the figures, a three-dimensional environment 1000 is mapped and a three-dimensional coordinate system 1002 is superimposed with that mapping. Distinctive features 1004 identified within the three-dimensional environment are associated with positions in the three-dimensional coordinate system. After identifying the distinctive features within the environment, a content author may use toolbox 1006 to select and identify specific features, or groups of features. For example, components 1008 and 1010 have been identified in FIG. 13 using the depicted toolbox. As shown in FIG. 14 the augmented reality maintenance system may also track and identify the labeled components even when the camera is moved to a new orientation.

### EXAMPLE

### Projecting Visual Prompts into a Three-Dimensional Environment

FIGS. 14-16 depict examples of an augmented reality maintenance system projecting information into a three-dimensional environment to instruct and/or prompt a user. The augmented reality maintenance system depicted in the figures is a mobile system integrated into a vest. However, stationary systems integrated into workbenches, or other appropriate devices, may also function similarly in terms of how information is projected into an environment. In one instance, an operator is guided by arrow 1100 to walk through a door. In another instance, an operator is instructed by arrow 1200 to actuate a specific key on a keypad. In yet another instance, an operator is instructed by arrow 1300 to remove a specific bolt during a computer repair.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

What is claimed is:

1. A method for providing an augmented reality, the method comprising:
identifying a feature within a three-dimensional environment;
projecting first information into the three-dimensional environment;
collecting an image of the three-dimensional environment and the projected information;
determining at least one of distance and orientation of the feature from the projected first information in the collected image;
identifying an object within the three-dimensional environment; and
performing markerless tracking of the object.

2. The method of claim 1 further comprising moving at least one of a camera and the object to get three-dimensional information related to the object.

3. The method of claim 1 further comprising projecting second information onto the object.

4. The method of claim 3 further comprising maintaining the projected second information on the object while moving.

5. The method of claim 1 wherein markerless tracking comprises SLAM techniques.

6. The method of claim 1 further comprising determining the distance from the size of the projected first information in the image.

7. The method of claim 1 further comprising determining the orientation from the shape of the projected first information in the image.

8. The method of claim 1 further comprising providing a single camera to collect the image.

9. The method of claim 1 further comprising performing at least one of a condition-based maintenance, training, planning, operations, manufacturing, and educational process.

10. The method of claim 1, wherein the first information is light.

11. A method for providing augmented reality, the method comprising:
collecting visual information of a three-dimensional environment;
identifying a plurality of features within the three-dimensional environment;
comparing the plurality of features to a visual signature to identify a situation;
performing markerless tracking of the plurality of features; and
providing a visual prompt to a user regarding the identified situation.

12. The method of claim 11, wherein the visual prompt is information projected into the three-dimensional environment.

13. The method of claim 11 further comprising selecting how much information is provided by the visual prompt.

14. The method of claim 11, wherein the visual signature comprises a subset of the plurality of features.

15. The method of claim 11 further comprising locating and providing information regarding the identified situation to the user.

16. The method of claim 11 further comprising tracking a user within the environment.

17. The method of claim 11 wherein the situation is at least one of a repair, training, planning, operations, manufacturing, and educational process.

18. The method of claim 17 further comprising monitoring the user's time on task to evaluate a performance of the user.

19. The method of claim 17 further comprising detecting errors by the user.

20. The method of claim 11, wherein the situation is a condition-based maintenance procedure.

21. The method of claim 20 further comprising automatically tracking at least one of parts usage and frequency of failure modes.

22. The method of claim 21 further comprising analyzing at least one of the parts usage and frequency of failure modes to identify components for reengineering.

23. The method of claim 21 further comprising analyzing at least one of the parts usage and frequency of failure modes to optimize a repair procedure sequence.

24. A method for providing augmented reality authoring, the method comprising:
using markerless identification to identify an object;
providing a user interface for labeling features on the identified object in an augmented reality; and
tracking the labeled features on the identified object.

25. The method of claim 24, further comprising projecting information onto the object.

26. The method of claim 25, wherein the projected information is light.

27. The method of claim 24, wherein markerless identification comprises SLAM techniques.

28. The method of claim 24 further comprising using the user interface to input instructions regarding the labeled features.

29. The method of claim 28 wherein the instructions regard a repair process.

30. The method of claim 24 wherein labeling features further comprises labeling features with at least one of text, icons, shapes, and arrows.

31. The method of claim 24 further comprising selecting a feature on the object to label with the user interface using a light source.

32. The method of claim 31, wherein the light source comprises a laser.

33. The method of claim 24 further comprising determining at least one of a three-dimensional position and orientation of the object within a three-dimensional environment.

34. A method for providing augmented reality, the method comprising:
providing a light source;
projecting information into a three-dimensional environment with the light source;
collecting an image with a camera, wherein the image comprises the information projected into the environment;
determining a first coordinate system of the camera from the information projected into the three-dimensional environment;
determining a second coordinate system of the light source from the information projected into the three-dimensional environment; and
determining a relative offset between the first and second coordinate systems.

35. The method of claim 34, wherein a relative offset is at least one of an angle and distance.

36. A method for providing augmented reality, the method comprising:
providing a camera;
collecting a first image of a three-dimensional environment with the camera;
automatically identifying a situation;
automatically determining an action to be performed from the identified situation;
performing the determined action;
collecting a second image of the three-dimensional environment with the camera; and
determining a response to the performed action.

37. The method of claim 36, wherein the identified situation is at least one of an aviation, manufacturing process, maintenance procedure, train, ship, and control room situation.

38. The method of claim 36, wherein the determined action comprises adjusting a system setting.

39. An augmented reality system comprising:
a camera;
a light source; and
a controller adapted to send a signal to the light source to project first information into a three-dimensional environment, receive a signal from the camera, identify a feature in the environment, determine at least one of distance and orientation of the feature using the first information, determine at least one of distance and orientation of a feature in the environment from the signal from the camera, identify an object within the three-dimensional environment, and track the object using markerless tracking.

40. The augmented reality system of claim 39 further comprising at least one of an infrared sensor, a high resolution camera, a curve tracer, an oscilloscope, a current probe, a voltage probe, and an ohmmeter.

41. The augmented reality system of claim 40, wherein the controller receives information from the at least one of the infrared sensor, the high resolution camera, the curve tracer, the oscilloscope, the current probe, the voltage probe, and the ohmmeter.

42. The augmented reality system of claim 39 further comprising an audio input device for receiving commands from a user.

43. The augmented reality system of claim 39 further comprising an audio output device for providing audible prompts to a user.

44. The augmented reality system of claim 39, wherein the controller tracks the feature using markerless tracking.

45. The augmented reality system of claim 39, wherein at least one of the camera, the projector, and the controller is worn by a user.

46. The augmented reality system of claim 39, wherein at least one of the camera, the projector, and the controller is integrated into a workbench.
